(19) United States
(12) Patent Application Publication
(10) Pub. No.: US 2007/0069650 A1
(43) Pub. Date: Mar. 29, 2007

(54) ELECTRODELESS LIGHTING SYSTEM HAVING ALUMINUM RESONATOR

(75) Inventors: Seok-Yeong Lee, Gyeonggi-Do (KR); Joon-Sik Choi, Seoul (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/536,234

(22) Filed: Sep. 28, 2006

(30) Foreign Application Priority Data
Sep. 28, 2005 (KR) 10-2005-0090816

(51) Int. Cl. H01J 11/00

(52) U.S. Cl. 313/608

(57) ABSTRACT

An aluminum resonator for an electrodeless lighting system includes an inner space configured to receive an electrodeless bulb that emits light by plasmarizing light emitting materials filled inside of the electrodeless bulb. The resonator is configured to transmit light generated by the electrodeless bulb, and the resonator is also configured to shield microwaves generated by a microwave generator and applied to the inner space of the resonator, from discharging to an exterior of the resonator, so that the microwaves are transferred to the electrodeless bulb thereby implementing a resonance mode.

### RELATED APPLICATION

The present disclosure relates to a subject matter contained in priority Korean Application No. 10-2005-0090816, filed on Sep. 28, 2005, which is herein expressly incorporated by reference in its entirety.

### BACKGROUND OF THE INVENTION

1. Field of the Invention

The present invention relates to an electrodeless lighting system having an aluminum resonator. More particularly, the present invention relates to an electrodeless lighting system having an aluminum resonator configured to prevent a decrease in a velocity of light due to a fading of, for example, silver coated on a resonator by heat generated from an electrodeless bulb.

2. Background of the Invention

FIG. 1 is a sectional view illustrating a structure of a related art electrodeless lighting system, and FIG. 2 is a linear sectional view taken along the line ‘II-II’ of FIG. 1.

As illustrated in FIGS. 1 and 2, a related art electrodeless lighting system includes a casing 10 in which a high voltage generator 20, a microwave generator 30 and a wave guide 40 are disposed, and a resonator 50 and an electrodeless bulb 60 each of which is disposed outside the casing 10. The electrodeless lighting system can be operated such that microwaves generated from the microwave generator 30 are introduced into the resonator 50 via the wave guide 40, and inactive gases filled in the electrodeless bulb 60 are plasmarized thereby emitting light.

The wave guide 40 is formed in a cylindrical tube. One side surface of the wave guide 40 is connected to the microwave generator 30. A resonator coupling member 41 having a predetermined height is protruded from an upper surface of the wave guide 40 along a height (longitudinal) direction of the wave guide 40.

The resonator coupling member 41 is formed in a ring (annular) shape having a diameter smaller than that of the wave guide 40, and its center is penetrated by the electrodeless bulb. The resonator 50 is fixedly coupled to an outer side of the resonator coupling member 41.

The resonator 50 is formed from a cylindrical mesh having a net-like structure such that the electrodeless bulb 60 is received in its inner space, microwaves are shielded from being discharged to the outside thus to be delivered to the electrodeless bulb 60, and light emitted from the electrodeless bulb 60 is transmitted to the outside.

The resonator 50 is formed of a steel material and has a cylindrical shape. A layer 52 coated with silver is provided on an inner surface of the resonator 50 so as to increase a reflectivity of the resonator 50.

A mirror 70 is formed in a circular plate having the same diameter as that of the resonator coupling member 41 and is in contact with an upper end of the resonator coupling member 41. The electrodeless bulb 60 having a predetermined length extends from the center portion of the mirror 70 in a height (longitudinal) direction of the wave guide 40 to be exposed outside of the wave guide 40.

The electrodeless bulb 60, on the other hand, includes a spherical light emitting portion 61 having a certain inner volume for filling a filling material, and a fixing portion 62 formed of the same material as that of the light emitting portion 61 and extended from the light emitting portion 61.

The light emitting portion 61 is installed inside the resonator 50 and the fixing portion 62 is installed to be formed into the center portion of the wave guide 40. The fixing portion 62 installed is connected to a motor shaft of a driving motor 90 which is installed in the casing 10 to rotate at a predetermined speed.

The light emitting portion 61 is preferably fabricated using a material such as quartz which has a high optical transmittance and an extremely low dielectric loss. The filling material filled in the light emitting portion 61 is constituted with a light emitting material such as metal, a halogen group compound, sulfur, selenium, or the like for forming a plasma to emit light, inactive gases such as argon gas, krypton gas, or the like for forming the plasma in the light emitting portion 61 at the beginning of the light emitting, and a discharge-catalyst material such as mercury for facilitating lighting by supporting an initial discharge or adjusting spectrum of light generated.

Reference numeral 80 denotes a reflector, 100 denotes a cooling fan, 110 denotes a second driving motor for rotating the cooling fan 100, and 120 denotes an air duct.

According to such construction, regarding the related art electrodeless lighting system, when a driving signal is input to the high voltage generator 20, the high voltage generator 20 boosts an alternative current (AC) power source and applies the boosted high voltage to the microwave generator 30, which is then oscillated by the high voltage to generate microwaves having an extremely high frequency. The generated microwaves are radiated (emitted) into the resonator 50 via the wave guide 40 and thereby inactive gases filled in the electrodeless bulb 60 are excited. Accordingly, light emitting material is continuously plasmarized thereby emitting light which has a specific discharge spectrum. The emitted light arrives at a surface of the mirror 70 disposed at a rear side of the electrodeless bulb 60 and is then reflected to a front side of the electrodeless bulb 60 to light up a space.

However, in the related art electrodeless lighting system, the resonator 50 is formed of the steel material and the silver-coated layer 52 is provided on the inner surface of the resonator 50, so as to increase the reflectivity. As the electrodeless lighting system is used for a long time, heat of high temperature generated from the electrodeless bulb 60 discolors (fades) the silver-coated layer 52 thereby lowering the reflectivity. Accordingly, the velocity of light generated from the electrodeless bulb is problematically decreased.

### SUMMARY OF THE INVENTION

Therefore, an object of the present invention is to provide an electrodeless lighting system including an aluminum resonator capable of preventing a decrease in a velocity of light due to a fading of silver coated on a resonator (e.g., caused by heat generated from an electrodeless bulb).

To achieve these and other advantages and in accordance with the purpose of the present invention, as embodied and broadly described herein, there is provided an electrodeless lighting system having an aluminum resonator including an electrodeless bulb that emits light by plasmarizing light emitting materials filled therein. In this regard, the aluminum resonator may receive the electrodeless bulb in an inner space of the resonator. Additionally, the resonator is configured to transmit light generated by the electrodeless bulb. Further, the resonator is configured to shield microwaves, which are generated by a microwave generator and applied to the inner space of the resonator, from discharging to an exterior of the resonator so that the microwaves are transferred to the electrodeless bulb thereby implementing a resonance mode.

According to another non-limiting embodiment of the present invention, there is provided an electrodeless lighting system having a resonator including an electrodeless bulb for emitting light by plasmarizing light emitting materials filled therein; and a resonator formed of a steel material for receiving the electrodeless bulb in an inner space thereof, and for transmitting light generated from the electrodeless bulb, allowing the electrodeless bulb to emit light by shielding microwaves, which have been generated from a microwave generator and applied to the inner space, from being discharged to the exterior thereby implementing a resonance mode. Additionally, an aluminum layer may be coated on an inner surface of the resonator.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The present invention is further described in the detail description which follows, in reference to the noted plurality of drawings, by way of non-limiting examples of preferred embodiments of the present invention, in which like characters represent like elements throughout the several views of the drawings, and wherein:

FIG. 1 is a sectional view illustrating a structure of a related art electrodeless lighting system;

FIG. 2 is a linear sectional view taken along the line ‘II-II’ of FIG. 1;

FIG. 3 is a sectional view illustrating a structure of an electrodeless lighting system having an aluminum resonator in accordance with one embodiment of the present invention;

FIG. 4 is a linear sectional view taken along the line ‘IV-IV’ of FIG. 3; and

FIG. 5 is a sectional view illustrating an electrodeless lighting system having an aluminum coated resonator in accordance with another embodiment of the present invention.

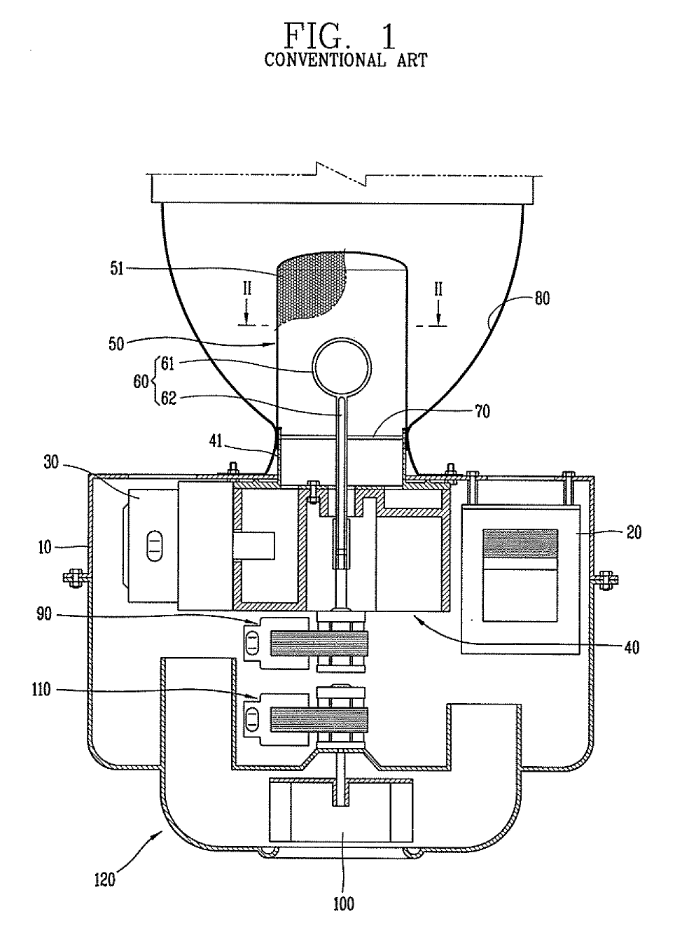

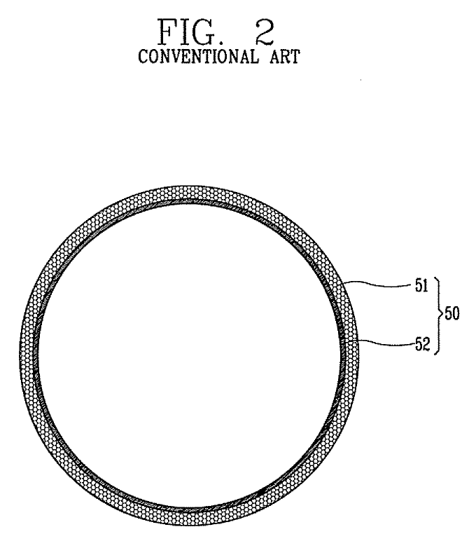

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

Description will now be given in detail of the present invention, with reference to the accompanying drawings.

However, the same portions as those in the related art construction may have the same reference numerals, and accordingly detailed description therefor will not be repeated.

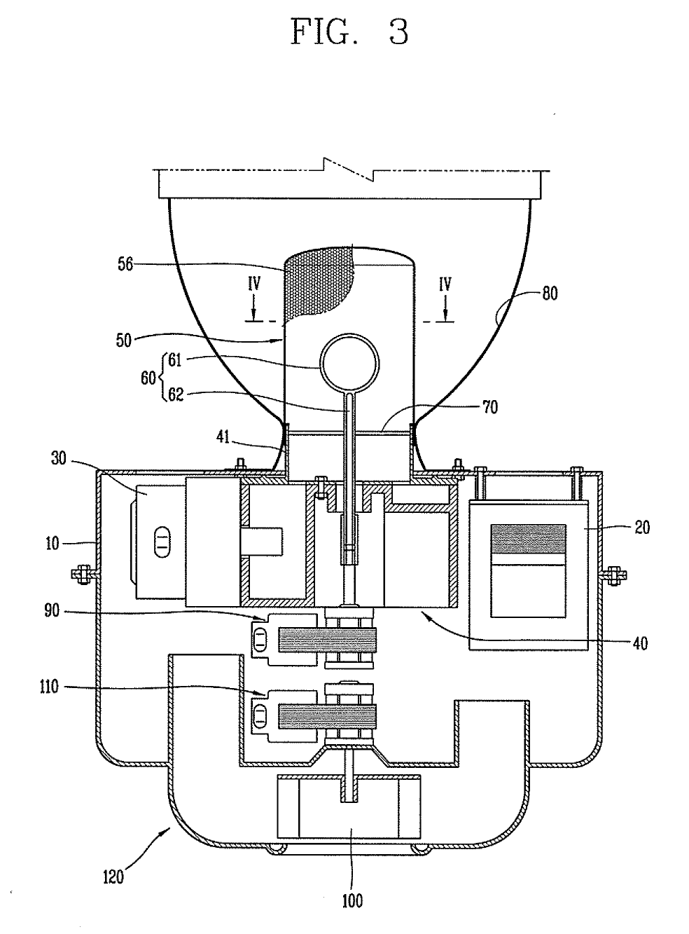

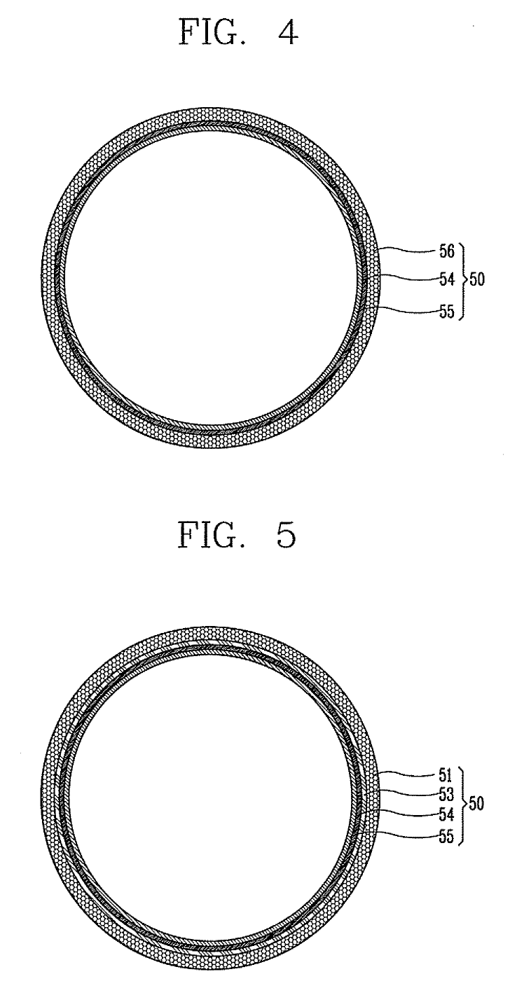

FIG. 3 is a sectional view illustrating a structure of an electrodeless lighting system having an aluminum resonator in accordance with a non-limiting embodiment of the present invention, FIG. 4 is a linear sectional view taken along the line ‘IV-IV’ of FIG. 3, and FIG. 5 is a sectional view illustrating an electrodeless lighting system having an aluminum coated resonator in accordance with another non-limting embodiment of the present invention.

As illustrated in the drawings, an electrodeless lighting system having an aluminum resonator 50 in accordance with one non-limiting embodiment of the present invention incldudes an electrodeless bulb 60 that emits light by plasmarizing light emitting materials filled therein, and a resonator 50 that is configured to receive the electrodeless bulb 60 in an inner space thereof. Additionally, the resonator may be configured to transmit light generated by the electrodeless bulb 60. Further, the resonator 50 is configured to shield microwaves, which are generated by a microwave generator 40 and applied to the inner space of the resonator, from discharging to an exterior of the resonator 50 so that the microwaves are transferred to the electrodeless bulb 60 thereby implementing a resonance mode.

The resonator 50 may be formed from a cylindrical mesh 56 having a generally net-like (or net-shape) structure such that the electrodeless bulb 60 may be received in the inner space thereof. In this regard, microwaves are shielded from being discharged to the exterior and are transferred (or delivered) to the electrodeless bulb 60. Further, light emitted from the electrodeless bulb 60 is transmitted to an exterior of the resonator. Additionally, it should appreciated that the resonator may be formed of any suitable shape having any suitable structure.

The resonator 50 may be formed of a steel material and have a generally cylindrical shape. An aluminum oxide layer Al₂O₃ 54 may be coated on an inner surface of the mesh 56 to prevent the mesh 56 from being corroded. Additionally, a high reflection coating layer 55 may be formed at an inner surface of the aluminum oxide layer Al₂O₃ 54 to increase a reflectivity of the resonator 50.

In general, the aluminum oxide layer Al₂O₃ 54 may be coated on a surface of the mesh 56 (e.g., which may be formed of aluminum) which is easily oxidized in air so as to prevent the mesh 56 from being oxidized.

According to such construction, regarding the electrodeless lighting system having the aluminum resonator in accordance with the non-limiting embodiments of the present invention, upon inputting a driving signal to the high voltage generator 20, the high voltage generator 20 boosts an alternative current (AC) voltage and applies the boosted high voltage to the microwave generator 30, which is then oscillated to generate microwaves having an extremely high frequency. The generated microwaves are radiated into the resonator 50 via a wave guide 40, whereby inactive gases filled in the electrodeless bulb 60 is excited to thereby continuously plasmarize light emitting materials, resulting in generation of light having a specific discharge spectrum

Here, the aluminum oxide layer Al₂O₃ 54 formed on the inner surface of the mesh 56 may prevent corrosion of the resonator 50 (e.g., formed of aluminum), and the high reflection coating layer 55 formed on the inner surface of the aluminum oxide layer Al₂O₃ 54 may decrease a loss of light generated from the electrodeless bulb 60. The light arrives at the surface of a mirror 70 disposed at a rear side of the electrodeless bulb 60 and may then be reflected to a front side of the electrodeless bulb 60 to light it up.

FIG. 5 is a sectional view illustrating an electrodeless lighting system having an aluminum coated resonator in accordance with another non-limiting embodiment of the present invention. The same portions as those in the one embodiment of the present invention may have the same reference numerals, and detailed description therefor will not be repeated accordingly.

A resonator of an electrodeless lighting system having an aluminum coated resonator in accordance with another non-limiting embodiment of the present invention may be formed of a steel material, similar to that of the related art electrodeless lighting system. Further, an aluminum layer 53 may be coated on an inner surface of the resonator 50. Additionally, an aluminum oxide layer 54 may be coated on an inner surface of the aluminum layer 53 to prevent corrosion of the aluminum layer 53. Further, a high reflection coating layer 55 may be disposed on an inner surface of the aluminum oxide layer 54 to increase a reflectivity of the resonator 50.

It is further noted that the foregoing examples have been provided merely for the purpose of explanation and are in no way to be construed as limiting of the present invention. While the present invention has been described with reference to a preferred embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. An electrodeless lighting system comprising:
an electrodeless bulb that emits light by plasmarizing light emitting materials filled therein; and
an aluminum resonator that receives the electrodeless bulb in an inner space thereof, wherein the resonator transmits light generated by the electrodeless bulb, and
wherein the resonator shields microwaves, which are generated by a microwave generator and applied to the inner space of the resonator, from discharging to an exterior of the resonator so that the microwaves are transferred to the electrodeless bulb thereby implementing a resonance mode.

2. The electrodeless lighting system of claim 1, wherein a corrosion preventer is disposed on an inner surface of the resonator.

3. The electrodeless lighting system of claim 2, wherein the corrosion preventer is an aluminum oxide layer Al₂O₃ coated on the inner surface of the resonator.

4. The electrodeless lighting system of claim 1, wherein a reflection coating layer is further disposed on the inner surface of the resonator.

5. The electrodeless lighting system of claim 4, wherein the reflection coating layer is a high reflection coating layer.

6. The electrodeless lighting system of claim 1, wherein the resonator has a generally cylindrical shape.

7. The electrodeless lighting system of claim 1, wherein the resonator is formed of a generally cylindrical mesh having a generally net-shaped structure.

8. An electrodeless lighting system comprising:
an electrodeless bulb that emits light by plasmarizing light emitting materials filled therein; and
a resonator formed of a steel material, and receiving the electrodeless bulb in an inner space thereof,
wherein the resonator transmits light generated by the electrodeless bulb, and
wherein the resonator comprises an aluminum layer coated on an inner surface of the resonator to shield microwaves, which are generated by a microwave generator and applied to the inner space, from discharging to an exterior of the resonator so that the microwaves are transferred to the electrodeless bulb, and a resonance mode is implemented

9. The electrodeless lighting system of claim 8, wherein a corrosion preventer is disposed on an inner surface of the resonator.

10. The electrodeless lighting system of claim 9, wherein the corrosion preventer is an aluminum oxide layer Al₂O₃ coated on the inner surface of the resonator.

11. The electrodeless lighting system of claim 10, wherein a reflection coating layer is further disposed on the inner surface of the resonator.

12. The electrodeless lighting system of claim 11, wherein the reflection coating layer is a high reflection coating layer.

13. The electrodeless lighting system of claim 8, wherein the resonator is formed of a generally cylindrical mesh having a generally net-shaped structure.

14. An aluminum resonator for an electrodeless lighting system, the aluminum resonator comprising:
an inner space configured to receive an electrodeless bulb that emits light by plasmarizing light emitting materials filled therein,
wherein the resonator is configured to transmit light generated by the electrodeless bulb, and
wherein the resonator is configured to shield microwaves generated by a microwave generator and applied to the inner space of the resonator, from discharging to an exterior of the resonator, so that the microwaves are transferred to the electrodeless bulb thereby implementing a resonance mode.

15. The aluminum resonator according to claim 14, wherein a corrosion preventer is disposed on an inner surface of the resonator.

16. The aluminum resonator according to claim 15, wherein the corrosion preventer is an aluminum oxide layer Al₂O₃ coated on the inner surface of the resonator.

17. The aluminum resonator according to claim 16, wherein a reflection coating layer is further disposed on the inner surface of the resonator.

18. The aluminum resonator according to claim 17, wherein the reflection coating layer is a high reflection coating layer.

19. The aluminum resonator according to claim 14, wherein the resonator has a generally cylindrical shape.

20. The aluminum resonator according to claim 14, wherein the resonator is formed of a generally cylindrical mesh having a generally net-shaped structure.
